(19) United States
(12) Patent Application Publication
(10) Pub. No.: US 2026/0008476 A1
(43) Pub. Date: Jan. 8, 2026

(54) VEHICLE SPEED ESTIMATION DEVICE, VEHICLE SPEED ESTIMATION METHOD, AND STORAGE MEDIUM

(71) Applicant: HONDA MOTOR CO., LTD., Tokyo (JP)

(72) Inventors: Masato Yamagishi, Wako-shi (JP); Tadashi Sumioka, Wako-shi (JP); Takuya Tsujimura, Wako-shi (JP); Sho Takayanagi, Wako-shi (JP); Kazushi Akimoto, Wako-shi (JP)

(21) Appl. No.: 19/250,199

(22) Filed: Jun. 26, 2025

(30) Foreign Application Priority Data
Jul. 4, 2024 (JP) 2024-108214

(51) Int. Cl. B60W 40/105; B60W 40/101; B60W 40/109; B60W 40/11; B60W 40/112; B60W 40/114

(52) U.S. Cl. CPC B60W 40/105; B60W 40/101; B60W 40/109; B60W 40/11; B60W 40/112; B60W 40/114; B60W 2300/365

(57) ABSTRACT

A vehicle speed estimation device of the embodiment includes an attitude angle estimator configured to estimate an attitude angle using an acceleration detected by an acceleration sensor and an angular speed detected by an angular speed sensor, which are attached to a vehicle, an angular speed corrector configured to correct the angular speed using the estimated attitude angle estimation value to calculate a corrected angular speed, a vector term calculator configured to calculate a gravity acceleration vector using the estimated attitude angle estimation value, a model configured to calculate an acceleration model value on the basis of a tire model using a steering angle of the vehicle and wheel speeds of wheels of the vehicle, and a vehicle speed estimator configured to estimate a vehicle speed of the vehicle using the corrected angular speed, the gravity acceleration vector, and the acceleration model value.

### CROSS-REFERENCE TO RELATED APPLICATION

Priority is claimed on Japanese Patent Application No. 2024-108214, filed Jul. 4, 2024, the content of which is incorporated herein by reference.

### BACKGROUND

### Field of the Invention

The present invention relates to a vehicle speed estimation device, a vehicle speed estimation method, and a storage medium.

### Description of Related Art

In recent years, efforts to provide access to a sustainable transportation system that takes into consideration vulnerable traffic participants have been gaining momentum. To realize this, people are focusing on research and development to further improve traffic safety and convenience through research and development on driving assistance.

In the driving assistance, motorcycles equipped with an inertial measurement unit (IMU) to detect a vehicle state and perform stabilization control are known (for example, Japanese Unexamined Patent Application, First Publication No. 2021-54184). To capture a change in roll moment, which causes the motorcycles to tip over, an estimation of the sideslip angle is required. To estimate the sideslip angle, it is necessary to estimate a vehicle speed.

### SUMMARY

However, in a conventional technology, acceleration and angular speed detected by a sensor in the IMU are used as they are, so that there is a risk that noise or the like in a sensor value will accumulate and the value will diverge.

The present invention has been made in consideration of the problems described above, and aims to provide a vehicle speed estimation device, a vehicle speed estimation method, and a storage medium that can perform vehicle speed estimation with high accuracy. This will ultimately contribute to a development of a sustainable transportation system.

(1): To achieve the object described above, a vehicle speed estimation device according to one aspect of the present invention includes an attitude angle estimator configured to estimate an attitude angle using an acceleration detected by an acceleration sensor and an angular speed detected by an angular speed sensor, which are attached to a vehicle, an angular speed corrector configured to correct the angular speed using the estimated attitude angle estimation value to calculate a corrected angular speed, a vector term calculator configured to calculate a gravity acceleration vector using the estimated attitude angle estimation value, a model configured to calculate an acceleration model value on the basis of a tire model using a steering angle of the vehicle and wheel speeds of wheels of the vehicle, and a vehicle speed estimator configured to estimate a vehicle speed of the vehicle using the corrected angular speed, the gravity acceleration vector, and the acceleration model value.

(2): In the vehicle speed estimation device according to the aspect of (1) described above, the model may use the wheel speed, the steering angle, the speed, the attitude angle, the angular speed, and the acceleration to calculate the acceleration model value in each of an x-axis direction, ae y-axis direction, and a z-axis direction by calculating forces in the x-axis direction, the y-axis direction, and the z-axis direction, acting on each of front wheels and rear wheels of the vehicle using the tire model, adding up the calculated forces of each axis acting on each of the front wheels and the rear wheels, and dividing a sum of the added forces by a weight of the vehicle.

(3): In the vehicle speed estimation device according to the aspect of (1) described above, the model may obtain an x-axis component of the acceleration model value on the basis of a relationship between a longitudinal slip ratio and a longitudinal force of a tire, obtain a y-axis component of the acceleration model value on the basis of a relationship between a wheel camber angle of the attitude angle and a lateral force of a tire, and calculate a z-axis direction of the acceleration model value by calculating the forces in the z-axis direction, acting on each of the front wheels and rear wheels of the vehicle, adding up the calculated forces of each axis acting on each of the front wheels and rear wheels, and dividing the sum of the added forces by the weight of the vehicle.

(4): In the vehicle speed estimation device according to the aspect of (1) described above, the device may further include a sideslip angle calculator configured to estimate a sideslip angle using the estimated x-axis component and y-axis component of the vehicle speed.

(5): In the vehicle speed estimation device according to the aspect of (4) described above, the device may further include a controller configured to control a roll moment caused by acceleration received from an inertial coordinate system using the estimated sideslip angle.

(6): To achieve the object described above, a vehicle speed estimation method according to another aspect of the present invention includes estimating, by an attitude angle estimator, an attitude angle using an acceleration detected by an acceleration sensor and an angular speed detected by an angular speed sensor, which are attached to a vehicle, correcting, by an angular speed corrector, the angular speed using the estimated attitude angle estimation value to calculate a corrected angular speed, calculating, by a vector term calculator, a gravity acceleration vector using the estimated attitude angle estimation value, calculating, by a model, an acceleration model value on the basis of a tire model using a steering angle of the vehicle and a wheel speed of a wheel of the vehicle, and estimating, by a vehicle speed estimator, a vehicle speed of the vehicle using the corrected angular speed, the gravity acceleration vector, and the acceleration model value.

(7): To achieve the object described above, a storage medium according to still another aspect of the present invention is a computer-readable non-transitory storage medium that has stored a program causing a computer of a vehicle speed estimation device to execute estimating an attitude angle using an acceleration detected by an acceleration sensor and an angular speed detected by an angular speed sensor, which are attached to a vehicle, correcting the angular speed using the estimated attitude angle estimation value to calculate a corrected angular speed, calculating a gravity acceleration vector using the estimated attitude angle estimation value, calculating an acceleration model value on the basis of a tire model using a steering angle of the vehicle and a wheel speed of a wheel of the vehicle, and estimating a vehicle speed of the vehicle using the corrected angular speed, the gravity acceleration vector, and the acceleration model value.

According to the aspects of (1) to (7) described above, it is possible to estimate a vehicle speed stably without a risk of error accumulation.

According to the aspect of (4) described above, it is possible to estimate a sideslip angle with high accuracy.

According to the aspect of (5) described above, it is possible to control a roll moment caused by acceleration from an inertial coordinate system.

### BRIEF DESCRIPTION OF THE DRAWINGS

FIG. 1 is a diagram which shows an example of an external shape of a saddle-ride type vehicle.

FIG. 2 is a diagram which shows an example of a configuration of a vehicle speed estimation system according to an embodiment.

FIG. 3 is a diagram which shows an example of lateral force.

FIG. 4 is a diagram which shows a vehicle model.

FIG. 5 is a diagram which shows an example of a calculation method for an acceleration model value.

FIG. 6 is a diagram for describing a symbol and the like used in calculating an actual wheel radius.

FIG. 7 is a flowchart which shows an example of processing of a control device according to an embodiment.

FIG. 8 is a diagram which shows an example of estimated value and an actual measured value of a sideslip angle based on a vehicle speed estimation of the embodiment.

### DESCRIPTION OF EMBODIMENTS

Hereinafter, embodiments of a vehicle speed estimation device, a vehicle speed estimation method, and a program of the present invention will be described with reference to the drawings. In the drawings used in the following description, a scale of each member is appropriately changed so that each member can be recognized.

In all drawings used to describe the embodiment, the same symbol is used for components having the same function, and repeated descriptions are omitted.

“On the basis of XX” in this application means “based on at least XX” and includes cases of being based on other elements in addition to XX. “On the basis of XX” is not limited to cases where XX is directly used, but also includes cases of being based on XX that has been subjected to calculation or processing. “XX” is any element (for example, any piece of information).

### External Shape of Vehicle

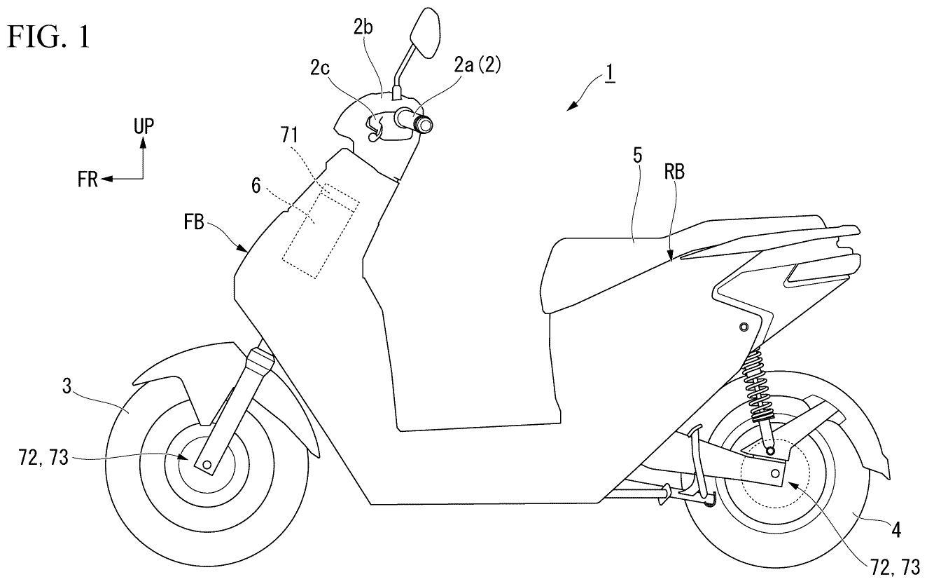

FIG. 1 is a diagram which shows an example of an external shape of a saddle-ride type vehicle. FIG. 1 shows a scooter-type two-wheeled vehicle 1 having a floor portion (low floor portion) on which a rider (driver) places his or her feet as an example of the saddle-ride type vehicle, but saddle-ride type vehicles are not limited to this.

The vehicle 1 is equipped with, for example, front wheels 3 which are steering wheels, rear wheels 4 which are driving wheels, a seat 5 on which the driver sits, a front body FB which is connected to a front of the floor portion, a rear body RB which is connected to a rear of the floor portion, a control device 6 (vehicle speed estimation device), an IMU 71, a steering angle sensor 72, and a wheel speed sensor 73.

The front wheels 3 can be steered by a bar handle (steering handle) 2.

On left and right sides of the bar handle 2, there are a pair of left and right grips 2a which the rider holds with the left and right hands, and a brake operator 2c which is operated by the rider to activate a brake device. A periphery of the bar handle 2 is covered with a handle cover 2b, except for the left and right grips 2a.

For example, the control device 6 and the IMU 71 are housed inside the front body FB. The steering angle sensor 72 and the wheel speed sensor 73 are attached to the front wheels and rear wheels, respectively.

### Vehicle Speed Estimation System

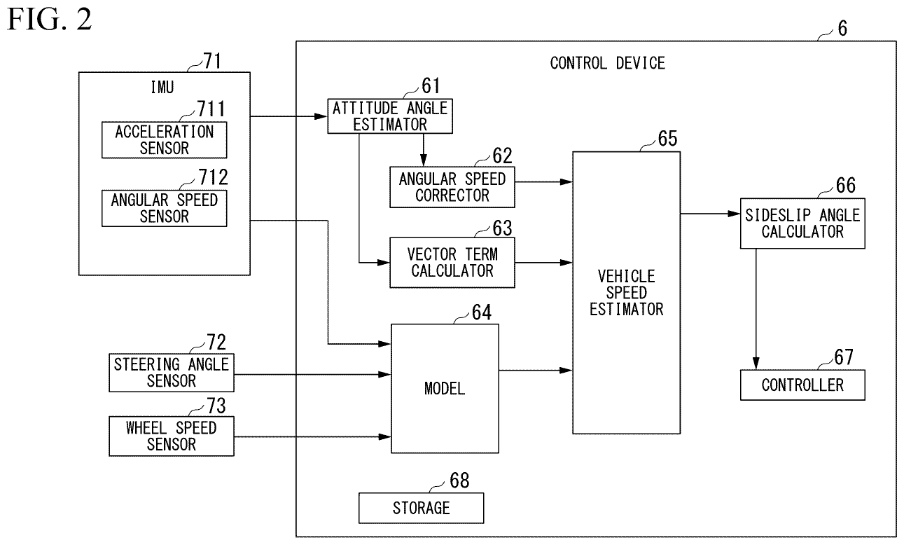

FIG. 2 is a diagram which shows an example of a configuration of a vehicle speed estimation system according to the present embodiment. The vehicle speed estimation system includes, for example, an IMU 71, a steering angle sensor 72, a wheel speed sensor 73, and a control device 6.

The control device 6 includes, for example, an attitude angle estimator 61, an angular speed corrector 62, a vector term calculator 63, a model 64, a vehicle speed estimator 65, a sideslip angle calculator 66, a controller 67, and a storage 68.

The IMU 71 includes, for example, an acceleration sensor 711 and an angular speed sensor 712.

The acceleration sensor 711 detects, for example, acceleration of the vehicle 1 in a forward and rearward direction, an upward and downward direction, and a leftward and rightward direction of the vehicle 1.

The angular speed sensor 712 detects, for example, an angular speed of the vehicle 1 in a pitch direction, a roll direction, and a yaw direction of the vehicle 1.

The steering angle sensor 72 detects, for example, a steering angle of the front wheels and a steering angle of the rear wheels.

The wheel speed sensor 73 detects, for example, a wheel speed of the front wheels and a wheel speed of the rear wheels.

The control device 6 is, for example, an engine control unit (ECU).

The attitude angle estimator 61 acquires a detection value from the acceleration sensor 711 and acquires a detection value from the angular speed sensor 712. The attitude angle estimator 61 estimates attitude angles (a pitch angle, a roll angle, and a yaw angle) of the vehicle 1 using the acquired acceleration and angular speed. While the vehicle 1 is traveling, acceleration due to gravity and centrifugal force occurs. For this reason, the attitude angle estimator 61 estimates the attitude angles using a known method for the angular speed and acceleration. A 3-axis acceleration sensor with which the IMU 71 is equipped outputs an amount of gravity acceleration g on 3 axes of a sensor local coordinate system, and Euler angles θ and φ can be calculated using an observation equation. The 3-axis gyro sensor outputs the angular speed around the 3 axes of the aircraft coordinate system, and the Euler angles ψ, θ, and φ (the attitude angles of the vehicle 1) can be calculated using a state equation. Since random errors (noise) are present and drift accumulates, the attitude angle estimator 61 may perform correction in a state space model of an extended Kalman filter.

The angular speed corrector 62 corrects the angular speed using the following conversion equation (1) for the attitude angles estimated by the attitude angle estimator 61 to calculate a corrected angular speed. ω is the angular speed, θ is the pitch angle, φ is the roll angle, and ψ is the yaw angle. A superscript “⋅” is a differential value, that is, an acceleration. A subscript “b” represents the attitude angle of a vehicle body. The angular speed corrector 62 outputs a corrected angular speed [ω] to the vehicle speed estimator 65.

$$[ \begin{matrix}{ω}_{x} \\ {ω}_{y} \\ {ω}_{z}\end{matrix} ] = [ \begin{matrix}1 & 0 & - sin {θ}_{b} \\ 0 & cos {ϕ}_{b} & sin {ϕ}_{b} cos {θ}_{b} \\ 0 & - sin {ϕ}_{b} & cos {ϕ}_{b} cos {θ}_{b}\end{matrix} ] [ \begin{matrix}\dot{{ϕ}_{b}} \\ \dot{{θ}_{b}} \\ \dot{{ψ}_{b}}\end{matrix} ] \qquad ( 1 )$$

The vector term calculator 63 calculates a gravity acceleration vector correction term [a^{g}] using the following conversion equation (2) for the attitude angles estimated by the attitude angle estimator 61. The vector term calculator 63 outputs the calculated gravity acceleration vector correction term [a^{g}] to the vehicle speed estimator 65.

$$[ \begin{matrix}{a}_{x}^{g} \\ {a}_{y}^{g} \\ {a}_{z}^{g}\end{matrix} ] = g [ \begin{matrix}- sin {θ}_{b} \\ sin {ϕ}_{b} cos {θ}_{b} \\ cos {ϕ}_{b} cos {θ}_{b}\end{matrix} ] \qquad ( 2 )$$

The model 64 may be an actual measured value or a simulation value. The model 64 is, for example, a vehicle body dynamics model using a tire model. The model 64 receives a detection value detected from the steering angle sensor 72, a detection value detected the wheel speed sensor 73, and a detection value detected by the IMU 71, and outputs an acceleration model value [a^{model}] of the following equation (3).

$${a}^{model} = [ \begin{matrix}{a}_{x}^{model} \\ {a}_{y}^{model} \\ {a}_{z}^{model}\end{matrix} ] \qquad ( 3 )$$

The vehicle speed estimator 65 calculates and estimates a vehicle speed [V] using the corrected angular speed [ω] output by the angular speed corrector 62, the gravity acceleration vector correction term [a^{g}] output by the vector term calculator 63, the acceleration model value [a^{model}] output by the model 64, and the following equation (4). [V^{⋅}] is translation. A matrix of 3 rows and 3 columns in a first item on a right side is a rotation matrix. Furthermore, the vehicle speed estimator 65 integrates, for example, the translation [V^{⋅}] at a predetermined time interval to obtain a vehicle speed V=[Vₓ V_{y} V_{z}]^{T} (T is a transpose).

$$[ \begin{matrix}\dot{{V}_{x}} \\ \dot{{V}_{y}} \\ \dot{{V}_{z}}\end{matrix} ] = - [ \begin{matrix}0 & - {ω}_{z} & {ω}_{y} \\ {ω}_{z} & 0 & - {ω}_{x} \\ - {ω}_{y} & {ω}_{x} & 0\end{matrix} ] [ \begin{matrix}{V}_{x} \\ {V}_{y} \\ {V}_{z}\end{matrix} ] + [ \begin{matrix}{a}_{x}^{model} \\ {a}_{y}^{model} \\ {a}_{z}^{model}\end{matrix} ] - [ \begin{matrix}{a}_{x}^{g} \\ {a}_{y}^{g} \\ {a}_{z}^{g}\end{matrix} ] \qquad ( 4 )$$

The sideslip angle calculator 66 uses an x-axis component and a y-axis component of the vehicle speed V to calculate a sideslip angle using a known method.

The controller 67 uses the sideslip angle to control a roll moment caused by acceleration from an inertial coordinate system. The controller 67 controls a roll moment caused by a movement of a mass point position and a movement of a contact point on the basis of a steering angle of each of the front wheels and rear wheels. The storage 68 stores equations, predetermined values, processing algorithms, and the like used by each unit.

### Model

Next, the model 64 will be described.

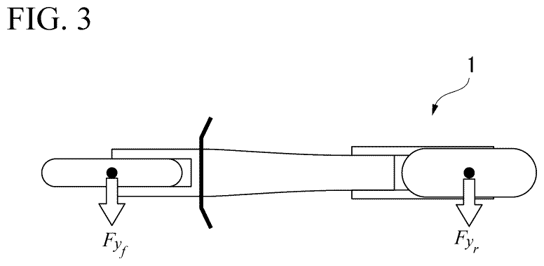

A moment generated in the two-wheeled vehicle 1 is divided into a roll moment caused by lateral acceleration from the inertial coordinate system and a roll moment caused by the movement of the mass point position and the movement of the contact point. The roll moment caused by lateral acceleration from the inertial coordinate system includes ground lateral acceleration from the inertial coordinate system. The ground lateral acceleration from the inertial coordinate system includes, for example, a vehicle speed, a wheel steering angle, a sideslip angle, and the like. Further, the ground lateral acceleration from the inertial coordinate system can be approximated by (Fy_{f}+Fyᵣ)/m, which is a value obtained by dividing a sum of tire lateral forces by a weight m of the vehicle 1, as shown in FIG. 3. FIG. 3 is a diagram which shows an example of lateral force. Fy_{f} is a lateral force (N) of a front wheel tire of the vehicle 1, and Fyᵣ is a lateral force (N) of a rear wheel tire of the vehicle 1. As a result of the simulation, when the vehicle speed is high, the roll moment caused by the lateral acceleration becomes dominant. For this reason, in the present embodiment, the sideslip angle is estimated to capture a change in the roll moment caused by the lateral acceleration, which is a dominant factor. It is necessary to estimate the vehicle speed to estimate the sideslip angle.

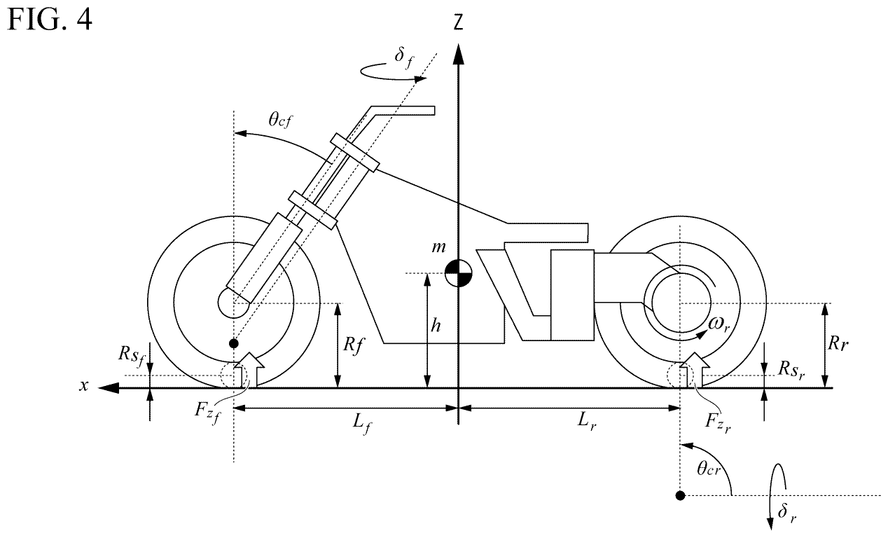

FIG. 4 is a diagram which shows a vehicle model. In FIG. 4, Fz_{f} is a force that the front wheels receive from a ground, and Fzᵣ is a force that the rear wheels receive from the ground. h is a distance from the ground to a center (or a center of gravity) of the vehicle 1. Lis an interval between the front wheels and the rear wheels, Lf is a distance from a center (or a center of gravity) of L to the front wheels, and Lr is a distance from the center (or the center of gravity) of L to the rear wheels. masen is obtained by multiplying acceleration detected by a sensor by the weight m of the vehicle.

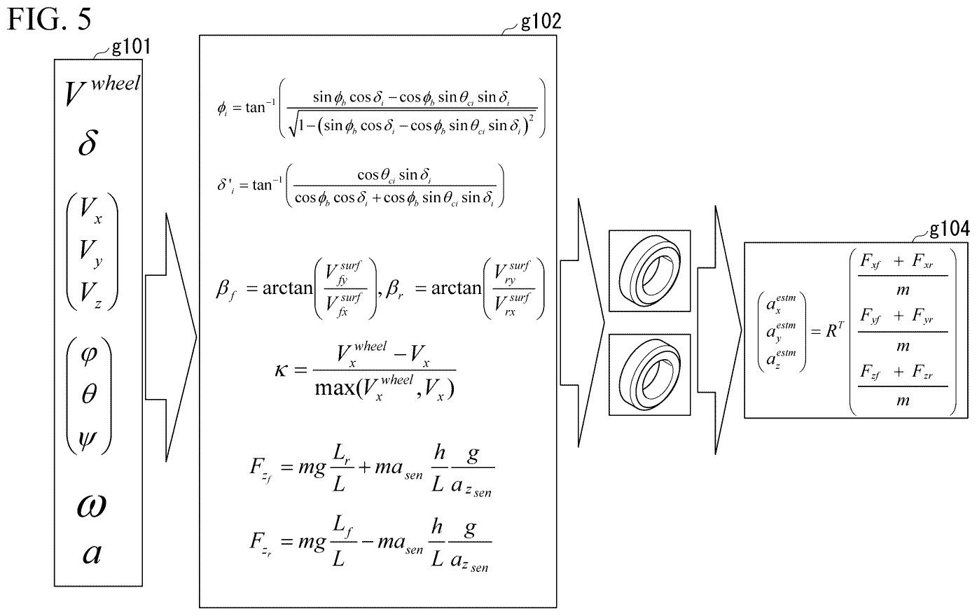

A flat belt testing machine for testing characteristics or the like of tires is known. In the present embodiment, for example, results of testing with this flat belt testing machine by adjusting test parameters and the like to a two-wheel limit region are used as a model. For example, values shown in FIG. 5 and values calculated based on vehicle body geometry and dynamics are used as a tire model to obtain the acceleration model value [a^{model}], which is an acceleration vector. FIG. 5 is a diagram which shows an example of a method for calculating the acceleration model value.

First, a value such as a symbol g101 shown in FIG. 5 is input to the model 64. V^{wheel} is a wheel speed, δ_{f} is a steering angle of the front wheels (rad), δᵣ is a steering angle of the front wheels (rad), and (Vx Vy Vz)^{T} is an estimated vehicle speed (a position of a center of gravity) one cycle before. A three-dimensional vehicle speed of the front rear wheels is calculated based on this estimated vehicle speed. A speed of the front rear wheels in an x direction is used to calculate a longitudinal slip ratio. (φ θ ψ)^{T} is a vehicle body attitude, ω is an angular speed, and a is an acceleration (m/s²).

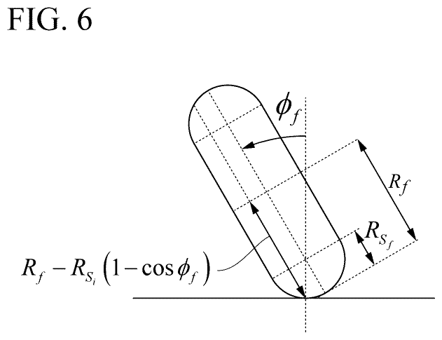

FIG. 6 is a diagram for describing symbols and the like used to calculate an actual wheel radius. θᵢ′ is an actual steering angle (actual yaw angle) of the front wheels or rear wheels, φᵢ is a roll angle of the front wheels or rear wheels, Rᵢ is a wheel radius of the front wheels or rear wheels, R_{S_i} is a cross-sectional radius of the front wheels or rear wheels, and θ_{ci} is a caster angle of the front wheels or rear wheels. i is front wheels f (front) and rear wheels r (rear). As shown in FIG. 6, the actual wheel radius is (Rᵢ−R_{S_i}(1−cosφᵢ).

Here, the wheel speed of the front wheels V_{wheel_f} and the wheel speed of the rear wheels V_{wheel_r} are expressed by the following equation (5).

$$\{ \begin{matrix}{V}_{{wheel}_{f}} = {ω}_{{wheel}_{f}} ( {R}_{f} - {R}_{{S}_{\text{?}}} ( 1 - cos {ϕ}_{f} ) ) \\ {V}_{{wheel}_{r}} = {ω}_{{wheel}_{r}} ( {R}_{r} - {R}_{S \text{?}} ( 1 - cos {ϕ}_{r} ) )\end{matrix} \qquad ( 5 )$$

$$\text{?} \text{indicates text missing or illegible when filed}$$

For example, as shown by a symbol g102, the model 64 performs each calculation using the tire model of the following equations (6) to (12). A superscript “sens” represents a detection value of the sensor, θ_{caster} is a caster angle, a subscript “f” represents the front wheels, a subscript “r” represents the rear wheels, κ represents a wheel slip ratio, and β represents a wheel sideslip angle (rad), a superscript “surf” represents a road surface coordinate system, ZMP is a center of gravity, z_{cog} is a distance from the road surface to the center of gravity in the z direction, and F is a force (N) (Fx is a longitudinal force, Fy is a lateral force, and Fz is a ground contact load). max( ) obtains a maximum value. In the road surface coordinate system, a z axis always faces vertically upward, and an x axis is perpendicular to the z axis and faces forward of the vehicle body, so that directions of the axes do not roll even if the vehicle body rolls.

$${δ}_{\text{?}}^{\text{?}} = {tan}^{- 1} ( \frac{cos {θ}_{c \text{?}} sin {δ}_{\text{?}}}{cos {ϕ}_{b} cos {δ}_{\text{?}} + cos {ϕ}_{b} sin {θ}_{c \text{?}} sin {δ}_{\text{?}}} ) \qquad ( 6 )$$

$${ϕ}_{\text{?}} = {tan}^{- 1} ( \frac{cos {ϕ}_{b} cos {δ}_{\text{?}} - cos {ϕ}_{b} sin {θ}_{c \text{?}} sin {δ}_{i \text{?}}}{\sqrt{1 - {( sin {ϕ}_{b} cos {δ}_{\text{?}} - cos {ϕ}_{b} sin {θ}_{c \text{?}} sin {δ}_{\text{?}} )}^{2}}} ) \qquad ( 7 )$$

$${B}_{f} = arctan ( \frac{{V}_{fx}^{surf}}{{V}_{f \text{?}}^{surf}} ) \qquad ( 8 )$$

$${B}_{y} = arctan ( \frac{{V}_{\text{?} y}^{surf}}{{V}_{\text{?}}^{surf}} ) \qquad ( 9 )$$

$$κ = \frac{{V}_{x}^{wheel} - {V}_{x}}{max ( {V}_{x}^{wheel} , {V}_{x} )} \qquad ( 10 )$$

$${F}_{{z}_{\text{?}}} = mg \frac{{L}_{\text{?}}}{L} + {ma}_{\text{?}} \frac{h}{L} \frac{g}{{a}_{{z}_{\text{?}}}} \qquad ( 11 )$$

$${F}_{{z}_{r}} = mg \frac{{L}_{f}}{L} - {ma}_{\text{?}} \frac{h}{L} \frac{g}{{a}_{{z}_{\text{?}}}} \qquad ( 12 )$$

$$\text{?} \text{indicates text missing or illegible when filed}$$

As in Equations (11) and (12), Fz is obtained by distributing the weight m of the vehicle 1 between the front wheels and the rear wheels at the center of gravity, taking into account the acceleration in the x direction when the vehicle body accelerates or decelerates, and also taking into account a load of the front wheels and the rear wheels in the x direction during braking and slowing.

As a result, the model 64 obtains the acceleration model value [a^{model}] (symbol g104, the following equation (13)). The superscript “estm” represents an estimated value.

$$( \begin{matrix}{a}_{x}^{estm} \\ {a}_{y}^{estm} \\ {a}_{z}^{estm}\end{matrix} ) = {R}^{T} ( \begin{matrix}\frac{{F}_{xf} + {F}_{xr}}{m} \\ \frac{{F}_{yf} + {F}_{yr}}{m} \\ \frac{{F}_{zf} + {F}_{zr}}{m}\end{matrix} ) \qquad ( 13 )$$

In Equation (13) and FIG. 4, R is a rotation matrix. By being multiplied by R^{T}, a road surface coordinate system is converted into a vehicle body coordinate system. The vehicle body coordinate system is a coordinate system in which the directions of the axes roll when the vehicle body rolls. The model 64, for example, as shown in Equation (13), calculates a three-dimensional acceleration model value (in each of the x-axis direction, y-axis direction, and z-axis direction) by calculating a longitudinal force of a tire, a lateral force of the tire, and a force in a z-axis direction of the tire, adding up the forces of each axis acting on the front wheels and rear wheels that have been calculated, and dividing a sum of these added forces by a weight m of the vehicle 1.

The tire model causes, for example, a physical model and a parameter to be learned by performing a test in a test mode using several types of tires on a flat belt testing machine in advance.

As a result, according to the present embodiment, instead of using the actual measured value detected by a sensor of the IMU 71 as it is, the model value is used to suppress divergence and enable accurate estimation of the vehicle speed. Learning of the model 64 may be performed online while the vehicle 1 is traveling.

For example, the model 64 may obtain (set) an x-axis component of the acceleration model value on the basis of a model showing a relationship between a longitudinal slip rate and the longitudinal force of the tire, and may obtain (set) a y-axis component of the acceleration model value on the basis of a model showing a relationship between a wheel camber angle of the attitude angle and the lateral force of the tire. In this case, the two models described above may be set in advance, or may be obtained based on actual measured values, simulation results, and the like. Furthermore, the model 64 may calculate a z-axis direction of the acceleration model value by calculating the forces in the z-axis direction, acting on each of front wheels and rear wheels of the vehicle, adding up the calculated forces of each axis acting on each of the front wheels and the rear wheels, and dividing a sum of the added forces by a weight m of the vehicle 1. The acceleration model value may be adjusted, for example, according to a type of the tire (for example, different tire manufacturers, different tire brands, different tire model numbers).

### Example of Processing Procedure

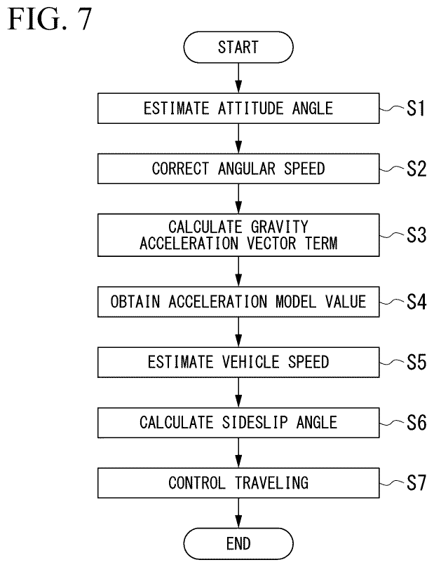

FIG. 7 is a flowchart which shows an example of processing by the control device according to the present embodiment.

(Step S1) The attitude angle estimator 61 acquires a detection value from the acceleration sensor 711 and a detection value from the angular speed sensor 712. Next, the attitude angle estimator 61 estimates the attitude angles (a pitch angle, a roll angle, and a yaw angle) of the vehicle 1 using the acquired acceleration and angular speed.

(Step S2) The angular speed corrector 62 corrects the angular speed using the conversion equation (1) for the attitude angles estimated by the attitude angle estimator 61.

(Step S3) The vector term calculator 63 calculates the gravity acceleration vector correction term [a^{g}] using the conversion equation (2) for the attitude angles estimated by the attitude angle estimator 61.

(Step S4) The model 64 receives the detection value detected from the steering angle sensor 72, the detection value detected from the wheel speed sensor 73, and the detection value detected by the IMU 71, and outputs the acceleration model value [a^{model}] of Equation (3).

(Step S5) The vehicle speed estimator 65 further performs integration using the corrected angular speed [ω] output by the angular speed corrector 62, the gravity acceleration vector correction term [a^{g}] output by the vector term calculator 63, and the acceleration model value [a^{model}] output by the model 64, and equation (4) to calculate and estimate the vehicle speed [V].

(Step S6) The sideslip angle calculator 66 calculates a sideslip angle using a known method, using the x-axis component and y-axis component of the vehicle speed V.

(Step S7) The controller 67 uses the sideslip angle to control the roll moment caused by acceleration received from the inertial coordinate system. The controller 67 controls the roll moment caused by the movement of the mass point position and the movement of the contact point on the basis of the steering angle of each of the front wheels and rear wheels.

The control device 6 repeats the processing described above while the vehicle 1 is traveling.

The processing procedures described above are merely examples, and are not limited to these. For example, some pieces of processing may be performed in parallel.

### Example of Evaluation Result

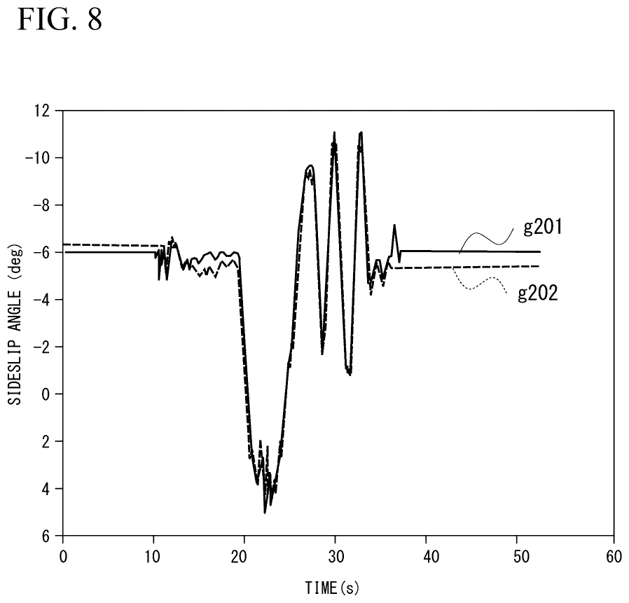

FIG. 8 is a diagram which shows an example of an estimated value and an actual measured value of a sideslip angle based on the vehicle speed estimation of the present embodiment. The horizontal axis represents a time(s), and the vertical axis represents a sideslip angle (deg). A line g201 is the estimated value, and a line g202 is the actual measured value. As shown in FIG. 8, a value of a sideslip angle estimated using a configuration and a method of the present embodiment is almost the same as the actual measured value.

As described above, in the present embodiment, instead of an output value of the IMU 71, model acceleration based on vehicle body dynamics and an angular speed derived from the attitude angle estimation value based on an IMU output are used as acceleration and an angular speed used for vehicle speed estimation.

As a result, according to the present embodiment, the vehicle speed can be estimated stably without a risk of error accumulation. As a result, according to the present embodiment, a sideslip angle can be estimated with high accuracy.

In the example described above, the vehicle 1 is described as having two wheels, but this is not limited thereto. The vehicle 1 may be, for example, a three-wheeled or four-wheeled vehicle. The vehicle 1 may be traveled by an engine, an engine and a motor, or a motor.

In the example described above, the IMU 71 is described as an example of a sensor that detects acceleration and an angular speed, but the present invention is not limited thereto. The sensor that detects acceleration and an angular speed may be a six-axis sensor, or a combination of an acceleration sensor and an angular speed sensor.

A program for implementing part or all of functions of the control device 6 in the present invention may be recorded on a computer-readable recording medium, and the program recorded on this recording medium may be read into a computer system and executed to perform all or part of processing performed by the control device 6. The “computer system” referred to here includes an OS and hardware such as peripheral devices. The term “computer system” includes a WWW system equipped with a home page providing environment (or display environment). The term “computer-readable recording medium” refers to a portable medium such as a flexible disk, an optical magnetic disc, a ROM, or a CD-ROM, or a storage device such as a hard disk embedded into a computer system. Furthermore, the term “computer-readable recording medium” also includes a device that holds a program for a certain period of time, such as volatile memory (RAM) inside a computer system that serves as a server or client when a program is transmitted via a network such as the Internet or a communication line such as a telephone line.

Each function of the control device 6 in the present invention is realized by a hardware processor such as a central processing unit (CPU) executing a program (software). In addition, some or all of these components may be realized by hardware (a circuit unit; including circuitry) such as an application specific integrated circuit (ASIC), a field-programmable gate array (FPGA), a graphics processing unit (GPU), a system on chip (SOC), and large scale integration (LSI), or may be realized by software and hardware in cooperation.

The program described above may be transmitted from a computer system in which the program is stored in a storage device or the like to another computer system via a transmission medium, or by transmission waves in the transmission medium. Here, the “transmission medium” that transmits the program refers to a medium that has a function of transmitting information, like a network (communication network) such as the Internet or a communication line (communication line) such as a telephone line. The program described above may be a program for realizing part of the functions described above. Furthermore, it may be a so-called differential file (differential program) that can realize the functions described above in combination with a program already recorded in the computer system.

Although the above describes a form for carrying out the present invention using the embodiment, the present invention is not limited to such an embodiment, and various modifications and substitutions can be made within a range not departing from the gist of the present invention.

What is claimed is:

1. A vehicle speed estimation device comprising:
an attitude angle estimator configured to estimate an attitude angle using an acceleration detected by an acceleration sensor and an angular speed detected by an angular speed sensor, which are attached to a vehicle;
an angular speed corrector configured to correct the angular speed using the estimated attitude angle estimation value to calculate a corrected angular speed;
a vector term calculator configured to calculate a gravity acceleration vector using the estimated attitude angle estimation value;
a model configured to calculate an acceleration model value on the basis of a tire model using a steering angle of the vehicle and wheel speeds of wheels of the vehicle; and
a vehicle speed estimator configured to estimate a vehicle speed of the vehicle using the corrected angular speed, the gravity acceleration vector, and the acceleration model value.

2. The vehicle speed estimation device according to claim 1,
wherein the model uses the wheel speed, the steering angle, the speed, the attitude angle, the angular speed, and the acceleration to calculate the acceleration model value in each of an x-axis direction, a y-axis direction, and a z-axis direction by calculating forces in the x-axis direction, the y-axis direction, and the z-axis direction, acting on each of front wheels and rear wheels of the vehicle using the tire model, adding up the calculated forces of each axis acting on each of the front wheels and the rear wheels, and dividing a sum of the added forces by a weight of the vehicle.

3. The vehicle speed estimation device according to claim 1,
wherein the model obtains an x-axis component of the acceleration model value on the basis of a relationship between a longitudinal slip ratio and a longitudinal force of a tire,
obtains a y-axis component of the acceleration model value on the basis of a relationship between a wheel camber angle of the attitude angle and a lateral force of a tire, and
calculates a z-axis direction of the acceleration model value by calculating the forces in the z-axis direction, acting on each of the front wheels and rear wheels of the vehicle, adding up the calculated forces of each axis acting on each of the front wheels and rear wheels, and dividing the sum of the added forces by the weight of the vehicle.

4. The vehicle speed estimation device according to claim 1, further comprising:
a sideslip angle calculator configured to estimate a sideslip angle using the estimated x-axis component and y-axis component of the vehicle speed.

5. The vehicle speed estimation device according to claim 4, further comprising:
a controller configured to control a roll moment caused by acceleration received from an inertial coordinate system using the estimated sideslip angle.

6. A vehicle speed estimation method comprising:
estimating, by an attitude angle estimator, an attitude angle using an acceleration detected by an acceleration sensor and an angular speed detected by an angular speed sensor, which are attached to a vehicle;
correcting, by an angular speed corrector, the angular speed using the estimated attitude angle estimation value to calculate a corrected angular speed;
calculating, by a vector term calculator, a gravity acceleration vector using the estimated attitude angle estimation value;
calculating, by a model, an acceleration model value on the basis of a tire model using a steering angle of the vehicle and a wheel speed of a wheel of the vehicle; and
estimating, by a vehicle speed estimator, a vehicle speed of the vehicle using the corrected angular speed, the gravity acceleration vector, and the acceleration model value.

7. A computer-readable non-transitory storage medium that has stored a program causing a computer of a vehicle speed estimation device to execute:
estimating an attitude angle using an acceleration detected by an acceleration sensor and an angular speed detected by an angular speed sensor, which are attached to a vehicle;
correcting the angular speed using the estimated attitude angle estimation value to calculate a corrected angular speed;
calculating a gravity acceleration vector using the estimated attitude angle estimation value;
calculating an acceleration model value on the basis of a tire model using a steering angle of the vehicle and a wheel speed of a wheel of the vehicle; and
estimating a vehicle speed of the vehicle using the corrected angular speed, the gravity acceleration vector, and the acceleration model value.
